(19) United States
(12) Patent Application Publication
(10) Pub. No.: US 2024/0296481 A1
(43) Pub. Date: Sep. 5, 2024

(54) Methods of Targeted Advertising and Interactive Kiosks

(71) Applicant: MEDIOS CATTRI, S.A. DE C.V., Ciudad de México (MX)

(72) Inventor: Victor Cattan Hamui, Mexico City (MX)

(21) Appl. No.: 18/593,938

(22) Filed: Mar. 3, 2024

Related U.S. Application Data
(60) Provisional application No. 63/488,409, filed on Mar. 3, 2023.

(51) Int. Cl. G06Q 30/0251; G06F 3/01; G06F 3/044; G06Q 30/0207; G06V 40/10; H04N 23/90

(52) U.S. Cl. CPC G06Q 30/0269; G06F 3/011; G06F 3/044; G06Q 30/0237; G06V 40/10; H04N 23/90

(57) ABSTRACT

An interactive kiosk can be used for targeted advertising. In some embodiments, the kiosk can include a camera, a microphone, a speaker, a screen, and/or a wireless communication device. In some embodiments, the kiosk collects and analyses data regarding an audience within a given proximity. In some embodiments, the kiosk can be used to access a variety of information. In some embodiments, the kiosk can enhance human interaction. In some embodiments, the kiosk can have a series of apps that can generate a digital code that can be sent to portable devices capable of reading code (such as smartphones or tablets). In some embodiments, the device performs an operation that correspond to the digital generated code. In some embodiments, the code can extend the human interaction, past the kiosk experience, for example, the experience could continue on a portables device after a user moves away from the kiosk.

### CROSS-REFERENCE TO RELATED APPLICATIONS

This application is related to and claims priority benefits from U.S. Provisional Application Ser. No. 63/488,409 filed on Mar. 3, 2023, entitled “Methods of Targeted Advertising and Interactive Kiosks”. The '409 application is hereby incorporated by reference herein in its entirety.

### FIELD OF THE INVENTION

This invention relates to methods, algorithms, systems, and/or computer applications for targeted advertising. In some embodiments, the invention relates to methods, algorithms, systems, and/or computer applications that utilize an advertisement kiosk. In some embodiments, the present disclosure is directed to an interactive kiosk. In some embodiments, the present disclosure is directed to an interactive kiosk with hardware and software configured to provide a user with a personalized experience.

Advertising kiosks can be used to market products and services. These kiosks are often located in commercial areas with a high amount of foot traffic, such as malls or outdoor shopping districts. In some traditional embodiments, these kiosks are large, backlit advertising spaces which can cycle through a limited number of printed advertisements.

With advances in digital display technologies, digital kiosks now offer more flexibility in advertising. For instance, a kiosk can cycle through a greater number of advertisements and advertisements can be updated or switched out more easily. However, there still exists a need for advertising kiosks that can provide a more personalized advertising experience.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of operating an interactive kiosk. Other embodiments of this aspect include corresponding computer systems, apparatus, and computer programs recorded on one or more computer storage devices, each configured to perform the actions of the methods.

One general aspect includes a method of engaging a user via a kiosk. The method can include displaying a default display on a screen of the kiosk; identifying the user via a camera; and/or displaying a personalized prompt on the screen based on the user. In some embodiments, the personalized prompt is an advertisement. In some embodiments, the personalized prompt is a user experience. In some embodiments, the user experience requires a user to strike a pose, where if the pose is done correctly the kiosk can give the user a reward. In some embodiments, the reward is a coupon. In some embodiments, the user experience includes creating an augmented reality visual based on information collected by the camera.

In some embodiments, the method can include sending information to a portable electronic device associated with the user.

In some embodiments, the method can include building an audience metrics database based on information received from the camera including at least one piece of audience analytical information.

In some embodiments, an interactive kiosk can include a front panel, a core, and/or a back panel. In some embodiments, the front panel can include a screen, a top camera, a first side camera, a microphone, a wireless communication device, and/or a speaker. In some embodiments the interactive kiosk can include a stand. In some embodiments the stand is telescopic. In some embodiments the screen is a touchscreen. In some embodiments the touchscreen is a projected capacitive multipoint touchscreen.

In some embodiments the screen has a film. In some embodiments the film is an anti-glare film. In some embodiments the film has antibacterial properties.

In some embodiments the screen is configured to display a user interface, where the user interface can include an icon bar and/or an information window. In some embodiments the icon bar includes at least one static object and a dynamic space. In some embodiments the interactive kiosk can include a microphone array. In some embodiments the microphone utilizes noise canceling technology.

In some embodiments the top camera is used to collect audience metrics. In some embodiments what is displayed on the screen is based on the audience metrics.

In some embodiments the interactive kiosk can include a second side camera. In some embodiments the first side camera is used to estimate a pose of a user in front of the interactive kiosk. In some embodiments the first side camera is used to create an augmented reality visual on the screen. In some embodiments the interactive kiosk can include a controller. In some embodiments the interactive kiosk can include a lidar sensor. In some embodiments the wireless communication device is an NFC reader.

### BRIEF DESCRIPTION OF THE DRAWINGS

FIG. 1 is a front view of an embodiment of an interactive kiosk.

FIG. 2 is a side view of an embodiment of an interactive kiosk.

FIG. 3 is a bottom view of an embodiment of an interactive kiosk.

FIG. 4 is a front perspective view of an embodiment of an interactive kiosk.

FIG. 5 is a front view of another embodiment of an interactive kiosk.

FIG. 6 is a view of a user interface of an embodiment of an interactive kiosk.

FIG. 7 is a schematic view of an embodiment of a controller.

FIG. 8 is a diagram of an example environment in which systems and/or methods described herein can be implemented.

FIG. 9 is a flowchart of an example process for engaging a user via a kiosk.

### DETAILED DESCRIPTION OF ILLUSTRATIVE EMBODIMENT(S)

A more detailed description of the device, systems, and methods in accordance with the present disclosure is set forth below. It should be understood that the description below of specific devices, systems, and methods is intended to be exemplary, and not exhaustive of all possible variations or applications. Thus, the scope of the disclosure is not intended to be limiting and should be understood to encompass other variations or embodiments.

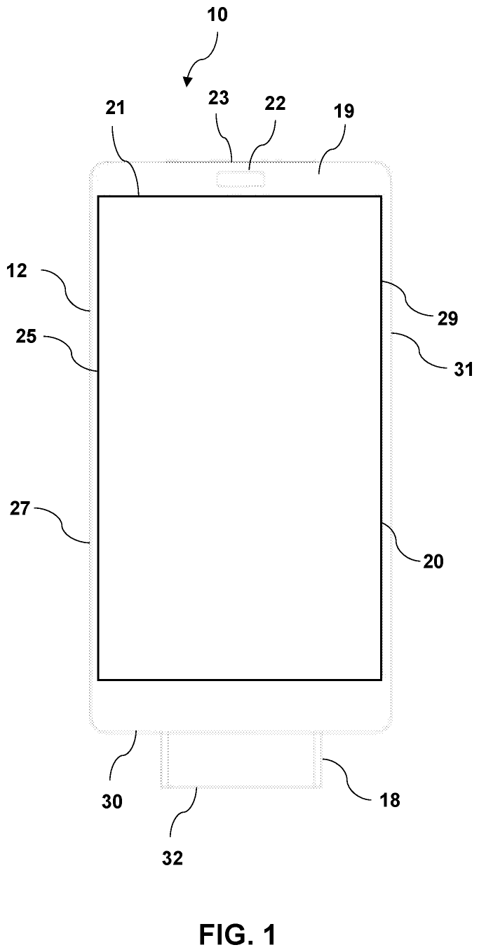

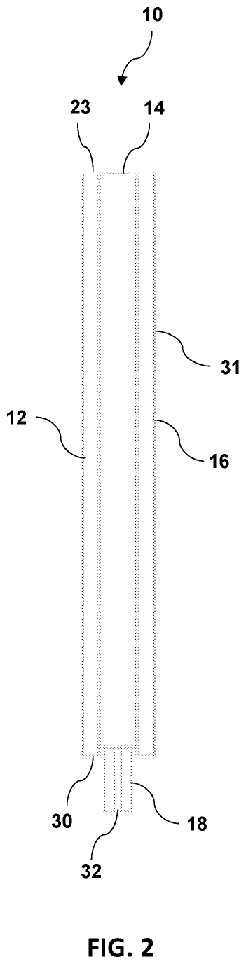

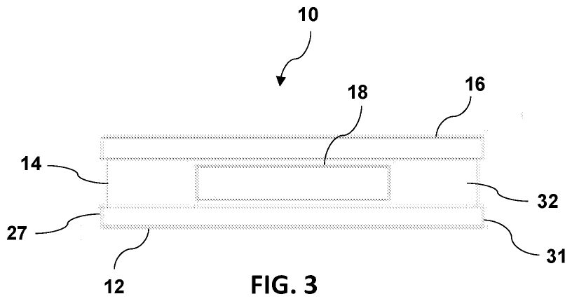

FIGS. 1-4 illustrate embodiments of interactive kiosk 10 that can be configured to display advertisement(s) and/or an interactive user experience(s). In some embodiments, the advertisement and/or interactive user experience is targeted to a particular individual and/or group of individuals. In some embodiments, kiosk 10 can display personalized advertisements or personalized interactive displays for a user.

In some embodiments, interactive kiosk 10 can include front panel 12, core 14, back panel 16, and/or stand 18. In some embodiments, front panel 12 can include hardware devices, such as, but not limited to, screen 20, top camera 22, side camera 24, microphone 15, wireless communication device 26, and/or speakers 28.

In some embodiments, kiosk 10 can be ergonomically designed to enhance a user's experience. For example, in some embodiments, the hardware devices included in kiosk 10 can be located in positions that are easily accessible for a user.

In some embodiments, kiosk 10 can display graphics and on-screen messages to help a user perform actions required for a personalized user experience. For example, in some embodiments, an on-screen message can assist a user to make a contactless payment using wireless communication device 26.

In some embodiments, front panel 12 and back panel 16 can be attached to opposite sides of core 14. For example, in some embodiments, core 14 can be sandwiched between front panel 12 and back panel 16. In some embodiments, core 14 can house components, such as, but not limited to, a controller.

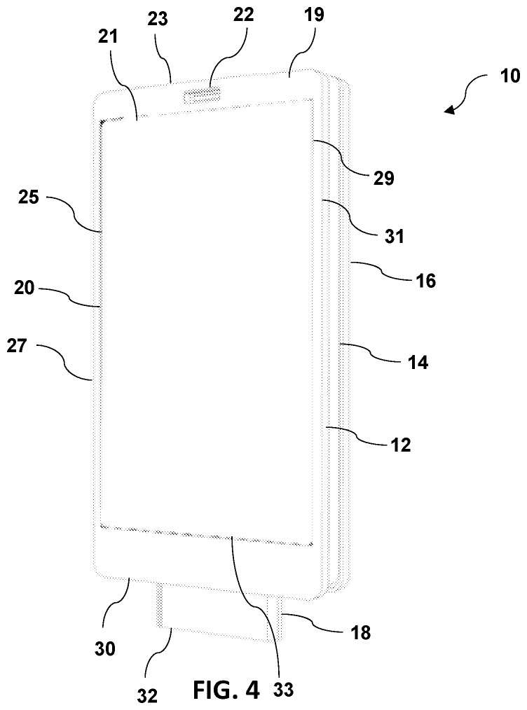

In the embodiments shown in FIGS. 1 and 4, stand 18 extends from the bottom edge 30 of kiosk 10. In some embodiments, stand 18 can be provided to place kiosk 10 in an upright position, extend the height of kiosk 10 to provide an ergonomic experience for a user, and/or to secure kiosk 10 to a surface such as a floor. In some embodiments, the height and/or angle (relative to the floor) of stand 18 can be adjusted. In some embodiments, stand 18 is telescopic. In some embodiments, stand 18 can be attached to the bottom of core 14. In some embodiments, stand 18 can be attached to front panel 12 and/or back panel 16. In some embodiments, stand 18 can be attached to front panel 12, back panel 16, and core 14. In some embodiments, stand 18 can have a width of about 52.1 cm (about 20.5 inches), a height of about 20 cm (about 7.87 inches), and a depth of about 8.6 cm (about 3.39 inches). In some embodiments, the depth can be modified based on the desired airflow. In some embodiments, such as those configured to be used outside, the depth can be about 12.5 cm (4.72 inches). In some embodiments, the depth can range from 1 inches-10 inches.

In some embodiments, bottom edge 32 of stand 18 can be secured to a surface (such as a floor) to keep kiosk 10 upright. In some embodiments, kiosk 10 is secured with traditional bolts. In some embodiments, kiosk 10 is secured with chemical bolts. Other methods of securing kiosk 10 can be used without departing from the scope of the disclosure. In some embodiments, stand 18 is connected to kiosk 10 at least partially via magnets.

In some embodiments, kiosk 10 does not utilize a stand. In some of these embodiments, bottom edge 30 of kiosk 10 can be secured to a surface.

In some embodiments, front panel 12 can display advertisements and/or provide an interactive experience for a user. For example, in some embodiments, front panel 12 can include screen 20, top camera 22, side camera 24, microphone 15, wireless communication device 26, and/or speakers 28. In some embodiments, front panel 12 can have a height of about 180 cm (about 70.87 inches) and a width of about 95 cm (about 37.40 inches). In some embodiments, screen 20 can be between 48″ to 90″ in size. In some embodiments, screen 20 can be between 55″ to 75″ in size. In some embodiments, screen 20 can be 65″ in size.

In some embodiments, a user can interact with kiosk 10 via screen 20 on front panel 12. For example, in some embodiments, screen 20 can be a touchscreen, such as, but not limited to, a projected capacitive multipoint touchscreen. In some embodiments, screen 20 can include layers of protective and/or functional film. For example, in some embodiments, screen 20 can include an anti-glare film. In some embodiments, the anti-glare film can be the outermost layer and/or can contain antibacterial properties. In some embodiments, screen 20 can also include a back solar visible enhancer (SVE) film for UV protection and image enhancement. In some embodiments, other films can be used without departing from the scope of the disclosure. In some embodiments, screen 20 is single sided. In some embodiments, screen 20 is double sided. In some embodiments, screen 20 is configured to withstand environmental conditions such as, but not limited to, inclement weather such as rain and/or snow.

In some embodiments, kiosk 10 can have screens 20 on multiple sides. In some embodiments, kiosk 10 has two screens 20. In some embodiments, the two screens are on opposite sides of kiosk 10 facing essentially opposite directions. In some embodiments, kiosk 10 has three screens 20 facing different directions. In some embodiments, kiosk 10 has four screens 20 facing different directions.

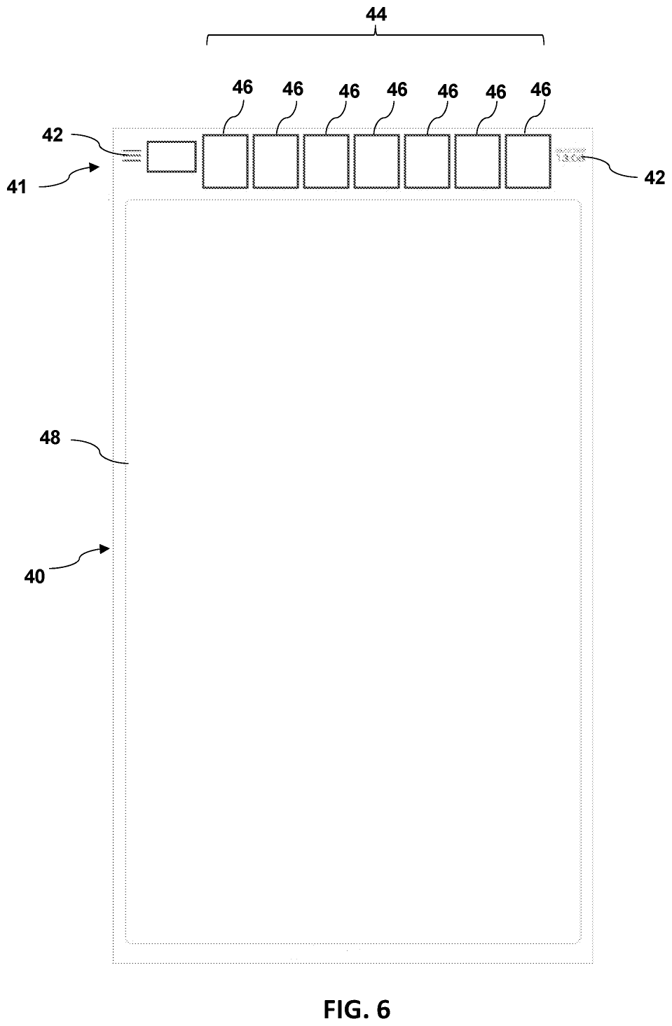

In some embodiments, screen 20 is configured to display a user interface, such as, for example, user interface 40 shown in FIG. 6. In some embodiments, a user can interact with kiosk 10 using user interface 40.

In some embodiments, when a user is in the proximity of kiosk 10, kiosk 10 can display a personalized advertisement and/or user experience.

In some embodiments, interface 40 can include icon bar 41. In some embodiments, icon bar 41 includes static objects 42 and/or dynamic space 44. In some embodiments, the offered services of the kiosk can be accessed via icon bar 41. In some embodiments, static objects 42 are icons which are constantly present on at least some embodiments of interface 40. In some embodiments, static objects 42 can include, among other things, a menu icon and/or a logo, such as a logo for the owner of the kiosk. In some embodiments, the time and/or date can also be static objects on interface 40. In some embodiments, a menu icon can be used to access features of kiosk 10, for instance, but not limited to, a widget display and/or a default display described herein. In some embodiments, other static icons can be present without departing from the scope of the disclosure.

In some embodiments, dynamic space 44 can display available apps 46. In some embodiments, dynamic space 44 changes based on how kiosk 10 is used. For example, in some embodiments, dynamic space 44 can be configured to display the most recently used apps or the most used apps. In some embodiments certain apps are always displayed in dynamic space 44.

In some embodiments, interface 40 can include information window 48 configured to display the contents of an app and/or advertisement. In some embodiments, information window 48 can have a 16:9 aspect ratio in vertical format and graphics dimensions of 2050×3645 pixels. In some embodiments, information window 48 can have graphic dimensions below ultra-high-definition (UHD). In some embodiments, information window 48 can have graphic dimensions at or above UHD. The aspect ratio and graphics dimensions can vary without departing from the scope of the disclosure.

In some embodiments, such as the embodiment illustrated in FIG. 6, icon bar 41 including static objects 42 and dynamic area 44 can be displayed across the top of user interface 40 and information window 48 can substantially cover the rest of user interface 40.

In some embodiments, the layout of user interface 40 can be customized by an end user, such as a kiosk owner. For example, in some embodiments, icon bar 41 can be displayed across the bottom of user interface 40 and below the information window. In some embodiments, icon bar 41 can be displayed vertically along either side of user interface 40. The layout of user interface 40 can vary without departing from the scope of the disclosure.

In some embodiments, such as the ones shown in FIGS. 1, 4, and 5, screen 20 can be surrounded by bezel 19. In some embodiments, bezel 19 can include at least one camera, at least one microphone, at least one wireless communication device, and/or at least one speaker.

In some embodiments, front panel 12 can include top camera 22 located in bezel 19 between top edge 21 of screen 20 and top edge 23 of kiosk 10. In some embodiments, top camera 22 can include a camera with a wide field of view. In some embodiments, top camera 22 can be used for audience analytics. For example, in some embodiments, top camera 22 can be used to build audience metrics such as the gender, age, sex, mood, and/or gaze of one or more individuals. In some embodiments, algorithms can use data collected from top camera about the audience to determine the possible visual impact of kiosk 10. In some embodiments, the data is processed at a remote server. In some embodiments, the data is processed directly on kiosk 10. In some embodiments, top camera 22 is used exclusively for audience analytics and does not capture video and/or is not capable of recognizing people. In some embodiments, data from top camera 22 is combined with other data, either collected from other components of kiosk 10 and/or originating from another location to determine the possible visual impact of kiosk 10. In some embodiments, kiosk 10 is configured to vary what is displayed on screen 20 and/or played on the speakers of kiosk 10 based on the audience analytics.

In some embodiments, kiosk 10 can also include side camera 24. In some embodiments, side camera 24 can be located in bezel 19 between left edge 25 of screen 20 and left edge 27 of kiosk 10 or between right edge 29 of screen 20 and right edge 31 of kiosk 10. In some embodiments, side camera 24 can be located at a height of about 90 cm (about 35.4 inches) to about 110 cm (about 43.31 inches) from bottom edge 33 of screen 20.

In some embodiments, kiosk 10 can include two side cameras on opposite sides of kiosk 10. In some embodiments, the two side cameras can be located at the same height. In some embodiments, the two side cameras can be staggered at different heights. In some embodiments, kiosk 10 can include multiple side cameras at different heights on the same side of kiosk 10. In some embodiments, kiosk 10 can include multiple side cameras at different heights on various sides of kiosk 10.

In some embodiments, side camera 24 can be coupled to controller 50 of kiosk 10. In some embodiments, side camera 24 can be a self-operating piece of hardware that can work as a single component and/or with controller 50. In some embodiments, side camera 24 is connected to a server on the cloud. In some embodiments, side camera 24 can include a vision processing unit, such as for example, an Intel® Movidius™ vision processing unit.

In some embodiments, side camera 24 is capable of processing a series of video algorithms, capable of executing machine learning (ML) code, and/or performing real time video processing. For example, in some embodiments, side camera 24 can estimate the pose of the user in front of kiosk 10. In some embodiments, side camera 24 can be used to create augmented reality visuals to be displayed on screen 20 of kiosk 10.

In some embodiments, the kiosk can direct a user to perform a certain pose. In some embodiments, a user is rewarded if the pose is done correctly. In some embodiments, the reward is a coupon.

In some embodiments, side camera 24 is configured to perform the same functions of top camera 22 as discussed in the present disclosure. In some embodiments, top camera 22 is configured to perform the same functions of side camera 24 as discussed in the present disclosure.

In some embodiments, top camera 22 and/or side camera 24 can be configured to detect when a user is in the proximity of kiosk 10. For instance, in some embodiments, the cameras can detect a person within 1 meter of the kiosk. In some embodiments, the cameras can detect a person between 0.5 m to 5 m of the kiosk. In some embodiments, when a user has been detected to be within a proximity of kiosk 10, the controller can direct kiosk 10 to display a personalized user experience.

In some embodiments, kiosk 10 can include at least one microphone 15. In some embodiments, a single microphone can be located in bezel 19 between right edge 29 of screen 20 and right edge 31 of kiosk 10. In some embodiments, kiosk 10 includes a microphone array. Multiple microphones can be located throughout the kiosk without departing from the scope of the disclosure. In some embodiments, the microphone(s) can contain noise and/or echo cancelling technology. In some embodiments, the microphone array can be used to triangulate the origin of a sound.

In some embodiments, the microphone(s) can be configured for speech instruction and interactivity. For example, in some embodiments, the microphone(s) can be configured to recognize voice commands to access information on kiosk 10. In at least some embodiments, this feature can be used to assist users with limited mobility, dexterity, and/or use of their arms.

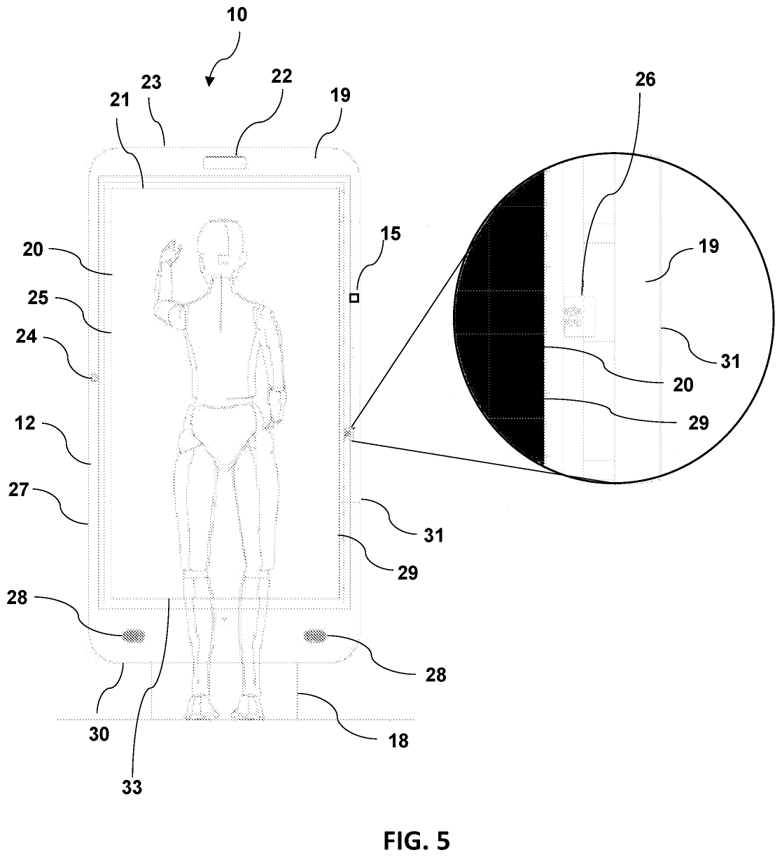

In some embodiments, kiosk 10 can include wireless communication device 26 as seen in FIG. 5. In some embodiments, using wireless communication device 26, a user can interact with certain apps and/or make in-app and/or other purchases on kiosk 10. For example, in some embodiments, wireless communication device 26 can be configured to accept payment using a contactless credit card and/or phone. In some embodiments, wireless communication device 26 can be located in bezel 19 between right edge 29 of screen 20 and right edge 31 of kiosk 10. In some embodiments, wireless communication device 26 can be located at a height that is easily accessible for a user. For instance, in some embodiments, wireless communication device 26 can be at a height of 100 cm (about 39.37 inches). in some embodiments, wireless communication device 26 can be at a height between 50 cm (19.6 inches) to 150 cm (59.0 inches).

In some embodiments, the height of wireless communication device 26 can be adjusted based on the height of the user. In some embodiments, this can be accomplished by using a track and a motor.

In some embodiments, wireless communication device 26 can be a near-field communication (NFC) reader. In some embodiments, wireless communication device 26 can transmit signals via one of several wireless communications protocols, such as Bluetooth, Wi-Fi, CDMA, 900 MHz, 3G/4G/5G/Cellular, near-field communication, and/or other communication protocols to a network. Other wireless communication devices can be used without departing from the scope of the disclosure.

In some embodiments, kiosk 10 can include at least one speaker 28. In some embodiments, such as the one shown in FIG. 5, kiosk 10 can include audio speaker(s) 28 located in bezel 19 of front panel 12. In some embodiments, speaker(s) 28 can be located between bottom edge 33 of screen 20 and bottom edge 30 of front panel 12. In some embodiments, speaker(s) 28 can be located between top edge 21 of screen 20 and top edge 23 of front panel 12. In some embodiments, multiple speakers can be located in bezel 19 of front panel 12. The location and number of speakers in kiosk 10 can vary without departing from the scope of the disclosure.

In some embodiments, kiosk 10 can include optical sensors, for example, optical sensors for image recognition through chroma variation.

In some embodiments, kiosk 10 can also include lidar and/or radar sensors. In some embodiments, the sensor(s) can be included in front panel 12 of kiosk 10. In some embodiments, the sensor(s) can be coupled to controller 50.

In some embodiments, kiosk 10 can include top camera 22 located between top edge 21 of screen 20 and top edge 23 of kiosk 10, side camera 24 located between left edge 25 of screen 20 and left edge 27 of kiosk 10, microphone 15 and/or wireless communication device 26 between right edge 29 of screen 20 and right edge 31 of kiosk 10, and/or two speakers 28 located between bottom edge 33 of screen 20 and bottom edge 30 of kiosk 10, wherein speakers 28 are on opposite edges of kiosk 10, respectively.

In some embodiments, back panel 16 of kiosk 10 can include the same components in the same arrangement as front panel 12. In some embodiments, back panel 16 of kiosk 10 can include at least some of the same components as front panel 12. For instance, in some embodiments, kiosk 10 can be a double-sided kiosk, wherein both front panel 12 and back panel 16 include screen 20, top camera 22, side camera 24, speakers 28, microphone 15, and/or wireless communication device 26. In some embodiments, back panel 16 can include only some of the hardware devices of front panel 12. In some embodiments, kiosk 10 is single sided, wherein back panel 16 simply provides a cover for core 14.

In some embodiments, at least some of the components of kiosk 10, including the devices in front panel 12, can be manufactured for use in particular environments. For example, in some embodiments, kiosk 10 can be configured to be used in an indoor, semi-outdoor, or outdoor environment. Based on the intended environment for the kiosk, kiosk 10 can be manufactured to withstand environmental conditions such as, but not limited to, direct sunlight, rain, snow, wind, high humidity, dust, vibrations, high/low temperatures, and/or other hazardous and/or extreme environment conditions. In some embodiments, kiosk 10 has an ingress protection (IP) code of at least IP66.

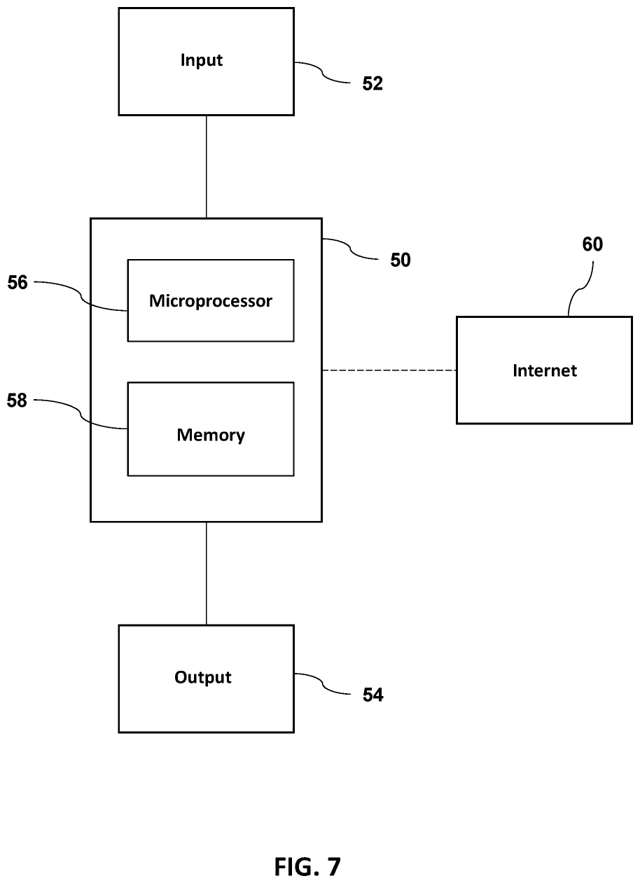

In some embodiments, kiosk 10 can be operated by controller 50. FIG. 7 shows a schematic embodiment of controller 50 in kiosk 10. In some embodiments, controller 50 can be housed in core 14. In some embodiments, controller 50 can be housed in front panel 12, core 14, and/or back panel 16.

In some embodiments, controller 50 can be coupled to inputs 52 and/or outputs 54. In some embodiments, inputs 52 can include, but are not limited to, top camera(s) 22, side camera(s) 24, microphone(s) 15, and/or wireless communication device(s) 26. In some embodiments, outputs 54 can include, but are not limited to, screen 20 and/or speaker(s) 28. In some embodiments, inputs 52 can send a signal to controller 50, controller 50 can receive and process the signal, and controller 50 can then operate an output 54 based on the processed signal.

In some embodiments, controller 50 can include microprocessor 56 (which can include multiple physical and/or virtual processors). In some embodiments, controller 50 can include one or more electrical circuits designed to carry out the actions described herein. In some embodiments, controller 50 can include microprocessor 56 and other circuits or circuitry. In some embodiments, controller 50 can include one or more memories 58. In some embodiments, the instructions by which microprocessor 56 is programmed can be stored on memory 58 associated with microprocessor 56. In some embodiments, memory 58 can include one or more tangible non-transitory computer readable memories, having computer executable instructions stored thereon, which when executed by microprocessor 56, can cause microprocessors 56 to carry out one or more actions as described herein. In some embodiments, controller 50 can also be coupled to the internet 60.

In some embodiments, controller 50 includes a multicore processor and/or a solid-state disk utilizing non-volatile memory express. In some embodiments, controller 50 runs a Linux® operating system.

In some embodiments, interactive kiosk 10 can provide a personalized user experience. In some embodiments, kiosk 10 can be programmed to run a “Default Advertisement Carousel.” In some embodiments, the Default Advertisement Carousel can display a pre-selected loop of advertisements based on the customer's specifications. In some embodiments, controller 50 can be configured to receive real time information to stop/resume the Default Advertisement Carousel. For instance, in some embodiments, when top camera(s) 22 and/or side camera(s) 24 detect a person within a proximity of kiosk 10, controller 50 can stop the Default Advertisement Carousel and can begin a personalized user experience. In some embodiments, camera controller 50 can process audience analytic information, for instance, but not limited to, gender, age, sex, mood, and/or gaze captured by top camera(s) 22 and/or side camera(s) 24 to personalize the user experience.

In some embodiments, based on the audience analytic information, the personalized experience can be a “call to action” (prompting the user to interact with the user interface) such as displaying a Wayfinder. In some embodiments, a Wayfinder shows a path on a map to a particular store selected by and/or suggested to a user. For example, kiosk 10 may be placed in a mall and suggest a particular end point, such as a store, to a user, kiosk 10 could then display a Wayfinder to direct the user to the store. In some embodiments, the Wayfinder could also be sent to a user's portable electronic device, such as a smartphone, to continue guiding the user to the endpoint.

In some embodiments, kiosk 10 can suggest a specific app.

In some embodiments if no action is taken by the user on kiosk 10 or if there is no user detected in the proximity of kiosk 10, controller 50 can resume the Default Advertisement Carousel.

In some embodiments, the rules defining the personalized user experience can be defined by a kiosk owner's needs. For example, in some embodiments, an owner can require that a Wayfinder appears on screen 20 when a particular user is detected in the proximity of kiosk 10.

In some embodiments, apps displayed on kiosk 10 can be web-based apps, designed and developed for specific purposes. In some embodiments, the kiosk can be provided with default apps, for example, but not limited to, apps for sports news, lifestyle news, and/or restaurant reservations. In some embodiments, the default apps can have a micro website coupled to the apps. In some embodiments, the apps can be configured to use the hardware and software of kiosk 10, for instance, top camera(s) 22, side camera(s) 24, speaker(s) 28, microphone(s) 15, wireless communication device 26, and/or specific application programming interfaces for connections to local and/or external services.

In some embodiments, kiosk 10 can display information in a widget format. In some embodiments, widgets can display a function of an app and offer a different way to access or consume the information in the app. In some embodiments, the user interface can display information in a single and/or multiple widgets. In some embodiments, the widgets could work as local apps and/or they could be external web widgets from third parties. In some embodiments, the web widgets can include, but are not limited to, weather, clock, events, news, and/or stock trading. In some embodiments, the widgets displayed can be personalized to a user within a proximity of kiosk 10. For instance, in some embodiments, when top camera(s) 22, and/or side camera(s) 24 detect a user within a proximity of kiosk 10, controller 50 can command screen 20 to display personalized widgets based on audience analytical information.

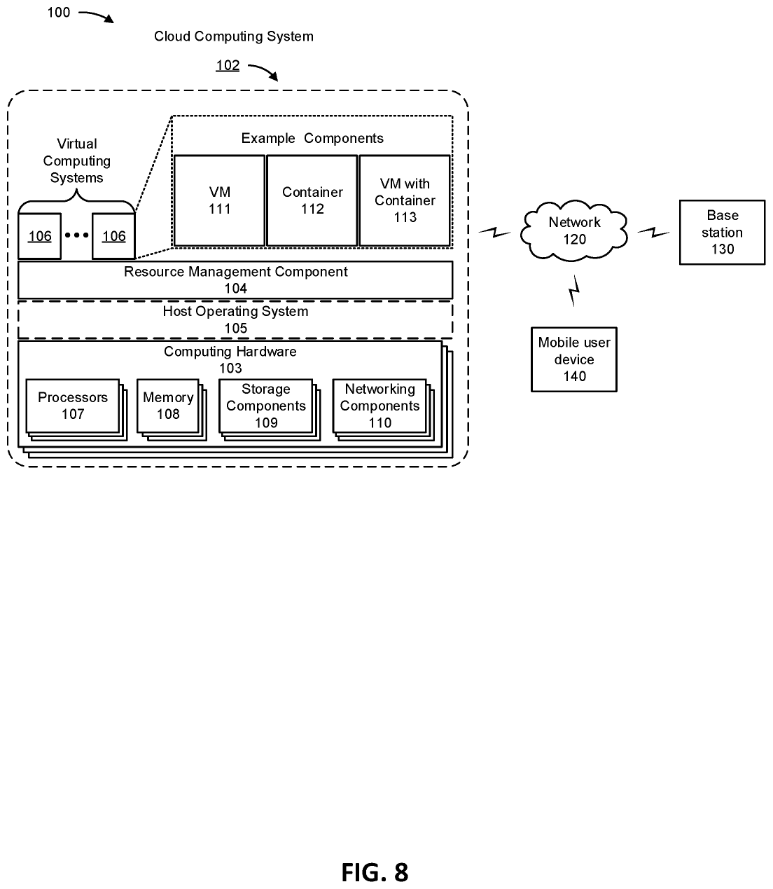

FIG. 8 is a diagram of an example environment 100 in which systems and/or methods described herein can be implemented. As shown in FIG. 8, environment 100 can execute within cloud computing system 102. Cloud computing system 102 can include one or more elements as described in more detail below. As further shown in FIG. 8, environment 100 can include network 120, base station 130, and/or user device 140. Devices and/or elements of environment 100 can interconnect via wired connections and/or wireless connections.

Cloud computing system 102 can include computing hardware 103, resource management component 104, host operating system (OS) 105, and/or one or more virtual computing systems 106. Resource management component 104 can perform virtualization (e.g., abstraction) of computing hardware 103 to create the one or more virtual computing systems 106. Using virtualization, resource management component 104 enables a single computing device (e.g., a computer, a server, and/or the like) to operate like multiple computing devices, such as by creating multiple isolated virtual computing systems 106 from computing hardware 103 of the single computing device. In this way, computing hardware 103 can operate more efficiently, with lower power consumption, higher reliability, higher availability, higher utilization, greater flexibility, and/or lower cost than using separate computing devices.

In some embodiments, computing hardware 103 includes hardware and corresponding resources from one or more computing devices. For example, computing hardware 103 can include hardware from a single computing device (e.g., a single server) or from multiple computing devices (e.g., multiple servers), such as multiple computing devices in one or more data centers. As shown, computing hardware 103 can include one or more processors 107, one or more memories 108, one or more storage components 109, and/or one or more networking components 110.

In some embodiments, resource management component 104 includes a virtualization application (e.g., executing on hardware, such as the computing hardware 103) capable of virtualizing computing hardware 103 to start, stop, and/or manage the one or more virtual computing systems 106. In some embodiments, resource management component 104 can include a container manager, such as when virtual computing systems 106 are containers 112. In some implementations, resource management component 104 executes within and/or in coordination with host operating system 105.

In some embodiments, virtual computing system 106 includes a virtual environment that enables cloud-based execution of operations and/or processes described herein using computing hardware 103. As shown, virtual computing system 106 can include virtual machine 111, container 112, hybrid environment 113 that includes a virtual machine and a container, and/or the like. In some embodiments, virtual computing system 106 can execute one or more applications using a file system that includes binary files, software libraries, and/or other resources required to execute applications on a guest operating system (e.g., within virtual computing system 106) or host operating system 105.

In some embodiments, network 120 includes one or more wired and/or wireless networks. For example, network 120 can include a cellular network, a public land mobile network (PLMN), a local area network (LAN), a wide area network (WAN), a private network, the Internet, and/or the like, and/or a combination of these or other types of networks. Network 120 enables communication among the devices of environment 100.

In some embodiments, base station 130 can support, for example, a cellular radio access technology (RAT). The base station can include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for user device 140. Base station 130 can transfer traffic between user device 140 (e.g., using a cellular RAT), one or more base stations (e.g., using a wireless interface or a backhaul interface, such as a wired backhaul interface), and/or a core network. Base station 130 can provide one or more cells that cover geographic areas.

In some embodiments, user device 140 includes one or more devices capable of receiving, generating, storing, processing, and/or providing information, as described elsewhere herein. In some embodiments, user device 140 can include a communication device and/or a computing device. For example, user device 140 can include a wireless communication device, a mobile phone, user equipment, a laptop computer, a tablet computer, a gaming console, a wearable communication device (e.g., a smart wristwatch, a pair of smart eyeglasses, a head mounted display, or a virtual reality headset), or a similar type of device.

The number and arrangement of devices and networks shown in FIG. 8 are provided as an example. In practice, there can be additional devices and/or networks, fewer devices and/or networks, different devices and/or networks, or differently arranged devices and/or networks than those shown in FIG. 8. Furthermore, two or more devices shown in FIG. 8 can be implemented within a single device, or a single device shown in FIG. 8 can be implemented as multiple, distributed devices. Additionally, or alternatively, a set of devices (e.g., one or more devices) of environment 100 can perform one or more functions described as being performed by another set of devices of environment 100.

In some embodiments, user device 140 can transmit signals via one of several wireless communications protocols, such as Bluetooth, Wi-Fi, CDMA, 900 MHz, 3G/4G/5G/Cellular, near-field communication, and/or other communication protocols to a network.

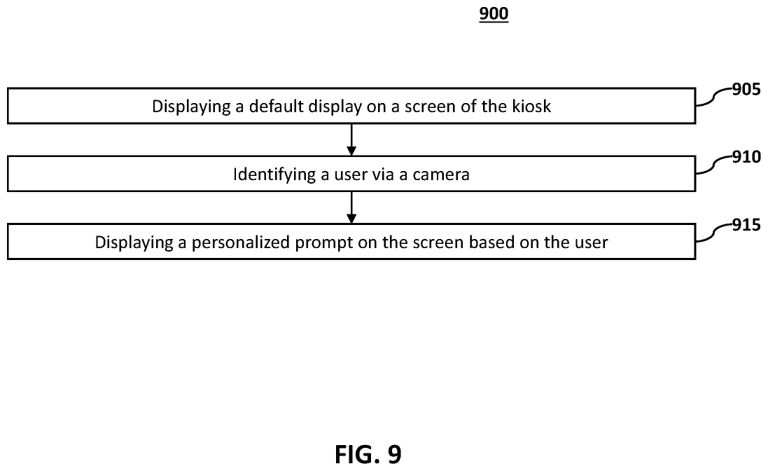

FIG. 9 is a flowchart of an example process 900. In some implementations, one or more process steps of FIG. 9 can be performed by a system.

As shown in FIG. 9, process 900 can include displaying a default display on a screen of the kiosk (step 905). For example, in some embodiments a system can display a default display on a screen of the kiosk, as described herein. As also shown in FIG. 9, process 900 can include identifying a user with a camera (step 910). For example, in some embodiments a system can identify a user with a camera, as described herein. As further shown in FIG. 9, process 900 can include displaying a personalized prompt on the screen based on the user (step 915). For example, in some embodiments a system can display a personalized prompt on the screen based on the user, as described herein.

Process 900 can include additional implementations, such as any single implementation or any combination of implementations described herein and/or in connection with one or more other processes described elsewhere herein.

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawings are to be regarded in an illustrative, rather than a restrictive sense.

Specific examples of systems, methods and apparatuses have been described herein for purposes of illustration. These are only examples. The technology provided herein can be applied to systems other than the example systems described above. Many alterations, modifications, additions, omissions, and permutations are possible within the practice of this invention.

This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Any numerical value ranges recited herein include all values from the lower value to the upper value in increments of one unit provided that there is a separation of at least two units between any lower value and any higher value. For example, if a range is listed from 1 to 100, specifically from 30 to 70, more specifically from 40 to 50, it is intended that values such as 25 to 75, 27 to 65, 45 to 60, 32 to 37, and so on, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or variants thereof, mean connection or coupling, either direct or indirect, permanent or non-permanent, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which perform the function of the described component.

In some embodiments, the application can be a mobile-based, cloud-based, server based and/or online-based application. In some embodiments, the devices can be a smartphone, tablet, laptop, smartwatch, or personal computer. In some embodiments, the application can be hosted by a commercially available platform. In some embodiments, the application can be embodied in a non-transitory computer-readable storage medium

Computer readable medium having program code recorded thereon for execution on a computer of the methods are disclosed above

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While particular elements, embodiments and applications of the present invention have been shown and described, it will be understood, that the invention is not limited thereto since modifications can be made without departing from the scope of the present disclosure, particularly in light of the foregoing teachings.

What is claimed:

1. An interactive kiosk comprising:
a front panel comprising
a screen;
a top camera;
a first side camera;
a microphone;
a wireless communication device; and
a speaker;
a core; and
a back panel.

2. The interactive kiosk of claim 1 further comprising:
a stand, wherein said stand is telescopic.

3. The interactive kiosk of claim 1 wherein said screen is a touchscreen.

4. The interactive kiosk of claim 3 wherein said touchscreen is a projected capacitive multipoint touchscreen.

5. The interactive kiosk of claim 1 wherein said screen has a film, wherein said film is an anti-glare film.

6. The interactive kiosk of claim 5 wherein said film has antibacterial properties.

7. The interactive kiosk of claim 1 wherein said screen is configured to display a user interface, wherein said user interface comprises:
an icon bar; and
an information window,
wherein said icon bar includes at least one static object and a dynamic space.

8. The interactive kiosk of claim 1 further comprising:
a microphone array, wherein said microphone utilizes noise canceling technology.

9. The interactive kiosk of claim 1 wherein said top camera is used to collect audience metrics.

10. The interactive kiosk of claim 9 wherein what is displayed on said screen is based on said audience metrics.

11. The interactive kiosk of claim 1 further comprising:
a second side camera; and
a lidar sensor.

12. The interactive kiosk of claim 1 wherein said first side camera is used to estimate a pose of a user in front of said interactive kiosk.

13. The interactive kiosk of claim 1 wherein said first side camera is used to create an augmented reality visual on said screen.

14. The interactive kiosk of claim 2 wherein said wireless communication device is an NFC reader.

15. A method of engaging a user via a kiosk, the method comprising:
displaying a default display on a screen of said kiosk;
identifying said user via a camera;
displaying a personalized prompt on said screen based on said user; and
building an audience metrics database based on information received from said camera including an at least one piece of audience analytical information.

16. The method of claim 15 wherein said personalized prompt is an advertisement.

17. The method of claim 15 wherein said personalized prompt is a user experience.

18. The method of claim 17 wherein said user experience includes creating an augmented reality visual based on information coming from said camera.

19. The method of claim 17 wherein said user experience requires said user to strike a pose, wherein if said pose is done correctly said kiosk give said user a reward, wherein said reward is a coupon.

20. The method of claim 15 further comprising:
sending information to a portable electronic device associated with said user.
